(19) United States
(12) Patent Application Publication
(10) Pub. No.: US 2025/0379437 A1
(43) Pub. Date: Dec. 11, 2025

(54) BUSWAY TAP-OFF BOX INTERLOCK

(71) Applicant: Eaton Intelligent Power Limited, Dublin (IE)

(72) Inventors: Walter James Lawlor, Hodges, SC (US); Andre Galante, Mechanicsville, VA (US)

(21) Appl. No.: 18/735,998

(22) Filed: Jun. 6, 2024

(51) Int. Cl. H02G 5/08; H01H 9/22

(52) U.S. Cl. CPC H02G 5/08; H01H 9/22

(57) ABSTRACT

A tap-off box includes: a housing including: an exterior, an interior, and a current path in the interior; a single mast including moveable electrical contacts electrically connected to the current path; a contact interface moveable between a connection position in which the moveable electrical contacts are positioned for electrical connection to a busway conductor and a disconnection position in which the moveable electrical contacts are not positioned for electrical connection to the busway conductor; a control interface that is moveable between an opened position in which the current path is open and a closed position in which the current path is closed; and an interlock that prevents movement of the contact interface from the connection position to the disconnection position when the control interface is in the closed position.

### TECHNICAL FIELD This disclosure relates to a busway tap-off box interlock.

### BACKGROUND Electrical power may be distributed throughout a building via cable and conduit. A busway system is an alternative to the traditional cable and conduit.

### SUMMARY

In one aspect, a tap-off box includes: a housing including: an exterior, an interior, and a current path in the interior; a single mast including moveable electrical contacts electrically connected to the current path; a contact interface moveable between a connection position in which the moveable electrical contacts are positioned for electrical connection to a busway conductor and a disconnection position in which the moveable electrical contacts are not positioned for electrical connection to the busway conductor; a control interface that is moveable between an opened position in which the current path is open and a closed position in which the current path is closed; and an interlock that prevents movement of the contact interface from the connection position to the disconnection position when the control interface is in the closed position.

Implementations include one or more of the following features.

The interlock may include a plate and an opening that passes through the plate. The opening may be over the control interface and the control interface may extend through the opening. The tap-off box may include a plurality of control interfaces, the interlock may include a plurality of openings, and each control interface may extend through one of the plurality of openings. The plate may include a main portion and a blocking portion; the plate may move with the control interface; and, when the control interface is in the closed position, the blocking portion may be between the connection position and the disconnection position such that the interlock prevents the contact interface from being placed in the disconnection position. The opening may pass through the main portion of the plate. The control interface may extend through the opening. The plate may be slideably mounted to the exterior.

In some implementations, the tap-off box has only a single contact interface, the plate is slideably mounted to the exterior, and the plate is mechanically coupled to the single contact interface. The control interface extends through the opening. The opening may be shaped such that the plate only moves with the interface when the control interface is in the opened position. The opening may be substantially L-shaped.

In another aspect, a tap-off box includes: a housing including: an exterior, an interior, and a current path in the interior; a mast including at least one electrical contact that is electrically connected to the current path; a contact interface moveable between a connection position in which the at least one electrical contact is positioned for electrical connection to a busway conductor and a disconnection position in which the at least one electrical contact is not positioned for electrical connection to the busway conductor; a control interface moveable between an opened position in which the current path is open and a closed position in which the current path is closed; and an interlock including: a blocking portion, and an opening positioned over the control interface, the interlock configured to move between a locked position corresponding to the closed position and an unlocked position corresponding to the opened position. When the control interface is in the closed position and the contact interface is in the connection position, the blocking portion prevents the contact interface from moving to the disconnection position.

Implementations may include one or more of the following features.

The interlock may include a plate including a main portion, and the blocking portion may extend from the main portion. The blocking portion may move into a space between the connection position and the disconnection position in response to the control interface moving into the closed position. The interior may include a plurality of current paths; the mast may include a plurality of electrical contacts; each of the plurality of electrical contacts may be connected to one of the plurality of current paths; the tap-off box may include a plurality of control interfaces, each control interface configured to open or close one of the plurality of current paths; and the interlock may include a plurality of openings, each opening positioned over one control interface. The blocking portion moves into the space between the connection position and the disconnection position in response to any of the plurality of control interfaces moving into the closed position.

The interior may include a plurality of current paths; the mast may include a plurality of electrical contacts; each of the plurality of electrical contacts connected to one of the plurality of current paths; the tap-off box may include a plurality of control interfaces, each control interface may be configured to open or close one of the plurality of current paths; and the opening may be positioned over all of the plurality of control interfaces. The blocking portion may move into the space between the connection position and the disconnection position in response to any of the plurality of control interfaces moving into the closed position.

In another aspect, an interlock for a tap-off box includes: a plate including: a main portion, and a blocking portion that extends from the main portion in a first direction; one or more control interface openings in the main portion, each control interface opening configured to be positioned over a control interface of the tap-off box; and a mounting device configured to attach the main portion of the plate to a mounting element on an exterior of the tap-off box such that, after attachment, the plate is configured to slide relative to the exterior of the tap-off box between a blocked position and an unblocked position in response to movement of a control interface.

Implementations may include one or more of the following features.

The mounting device may include a mounting opening configured to receive a shoulder bolt that extends from an exterior of the tap-off box.

The blocking portion may have an extent in a second direction that is less than an extent of a travel path of a moveable interface on the tap-off box.

Implementations of any of the techniques described herein may include an apparatus, a device, a system, a busway tap-off box, a busway system, a kit for retrofitting an existing busway tap-off box, an interlock for a busway tap-off box, and/or a method. The details of one or more implementations are set forth in the accompanying drawings and the description below. Other features will be apparent from the description and drawings, and from the claims.

### DRAWING DESCRIPTION

FIG. 1A is a block diagram of a system that includes a facility with a busway portion.

FIG. 1B is a side exterior view of the busway portion of FIG. 1A.

FIG. 1C is a side exterior view of a tap-off box.

FIG. 1D shows an electrical contact.

FIG. 2A is a perspective view of a tap-off box.

FIG. 2B shows an interlock.

FIG. 2C is a partial side view of the tap-off box of FIG. 2A.

FIG. 2D is a perspective view of a connector.

FIG. 2E shows the tap-off box of FIG. 2A with the interlock disengaged.

FIG. 2F shows the tap-off box of FIG. 2A with the interlock engaged.

FIG. 3 shows an interlock that is configured to be attached to a tap-off box.

FIGS. 4A-4C are front views of a tap-off box.

FIG. 5 shows another interlock.

FIGS. 6A-6C show the interlock of FIG. 5 attached to a front side of the tap-off box of FIG. 5.

### DETAILED DESCRIPTION

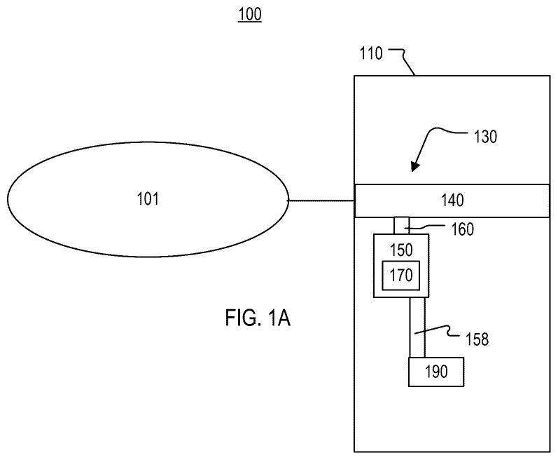

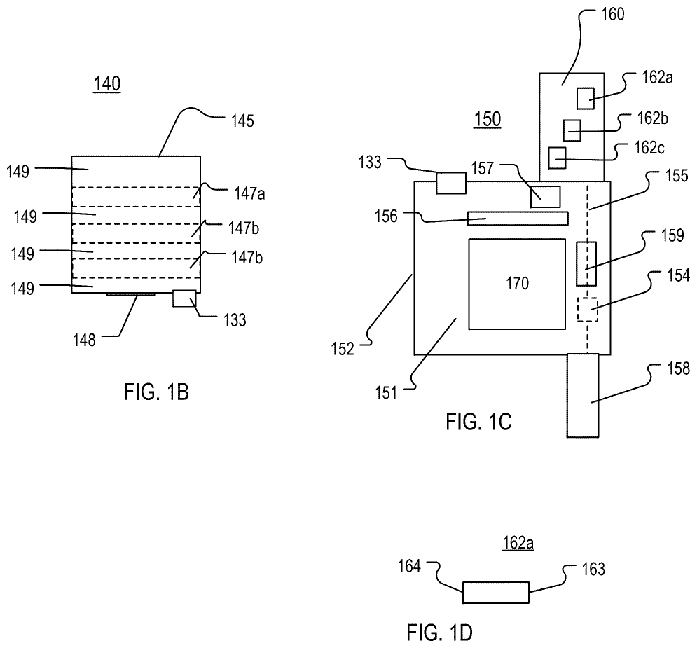

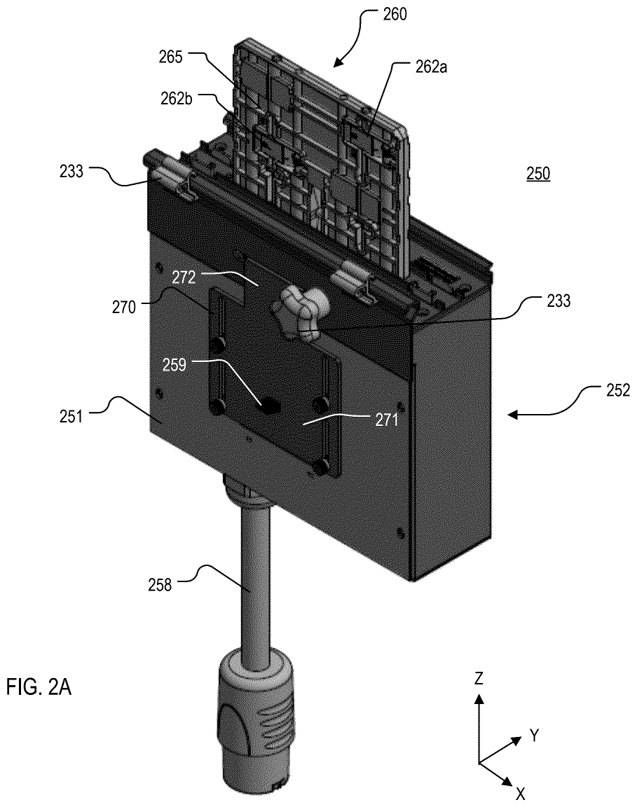

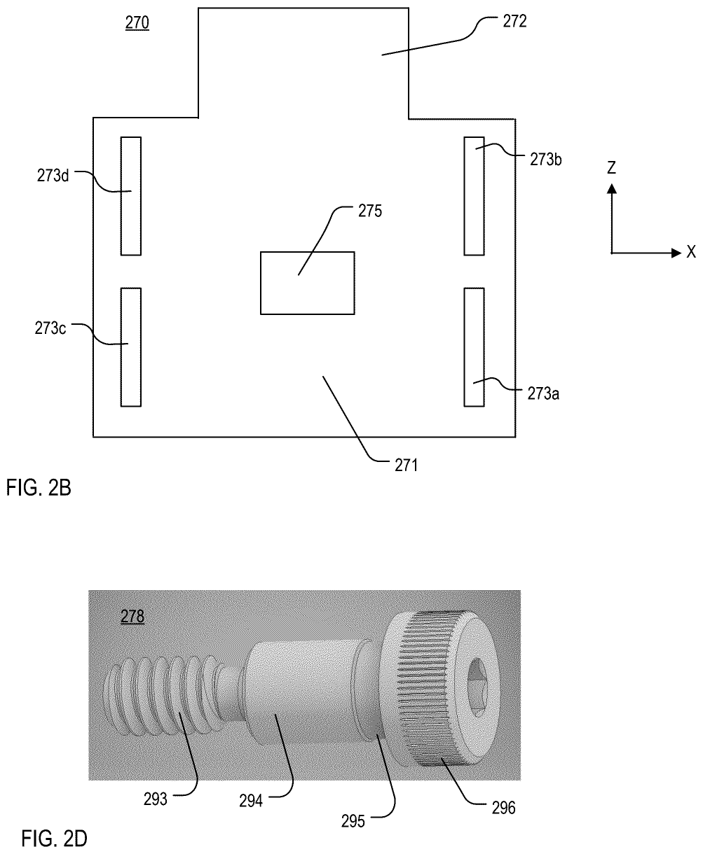

FIG. 1A is a block diagram of a system 100 that includes a facility 110 that receives electrical power from and/or provides electrical power to a power grid 101. Within the facility 110, electrical power is distributed to one or more power consuming and/or power generating devices 190 by a busway system 130. The busway system 130 is used to distribute electrical power throughout the facility 110 instead of or in addition to a traditional cable and conduit power distribution system. The busway system 130 has a configuration and size that is appropriate for the facility 110. For example, the busway system 130 may be configured to distribute electrical power having an RMS voltage of 600 volts (V) or less and currents of up to 600 amperes (A). In another example, the busway system 130 may be configured to distribute electrical power having RMS voltages of greater than 600V and/or currents greater than 600A. Moreover, the busway system 130 may distribute DC electrical power in addition to or instead of time-varying or AC electrical power. Furthermore, the modular nature of the busway system 130 allows the owner, operator, or other entity to reconfigure the busway system 130 as appropriate.

The busway system 130 includes a track style busway portion 140 and a tap-off box 150. The tap-off box 150 can be attached to and removed from the busway portion 140. When attached to the busway portion 140, the tap-off box 150 can deliver electrical power to a load (the device 190 in FIG. 1A) that is electrically connected to the tap-off box 150. As discussed in greater detail below, the tap-off box 150 includes an interlock 170 that prevents the tap-off box 150 from being electrically disconnected from the busway portion 140 while the tap-off box 150 powers the load. Traditional tap-off boxes lack the interlock 170. As compared to traditional tap-off boxes, the tap-off box 150 is safer to use, easier to operate and maintain, has a longer life, and improves the overall performance of the busway system 130.

An overview of the system 100 is provided prior to discussing the tap-off box 150 and the interlock 170 in more detail.

The facility 110 is any structure or area in which the busway system 130 is installed to provide electrical power to one or more of the devices 190. For example, the facility 110 may be a hospital, an office or apartment building, a retail establishment, a high rise, a factory, an airport or other transportation facility, or a data center. The facility 110 may be a region or area that is not necessarily enclosed in a building or an area that is partially exposed. For example, the facility 110 may be a construction site or a temporary structure. The device 190 may be any device or system that consumes and/or generates electrical power. Specific examples of the device 190 include, without limitation, computing equipment, medical devices, industrial machinery and equipment, generators, power converters, medical equipment, and lighting systems.

The power grid 101 distributes electrical power to commercial, residential, industrial, and/or municipal facilities. The power grid 101 is an alternating current (AC) power grid with a fundamental frequency of, for example, 50 or 60 Hertz (Hz). The power grid 101 may be a multi-phase (for example, three-phase) power grid. The power grid 101 may be low-voltage (for example, up to 1 kilovolt (kV)), medium-voltage or distribution voltage (for example, between 1 kilovolts (kV) and 35 kV), or high-voltage (for example, 35 kV and greater). The power grid 101 may include more than one sub-grid or portion. For example, the power grid 101 may include AC micro-grids, AC area networks, or AC spot networks that serve particular customers. These sub-grids may be connected to each other via switches and/or other devices to form the power grid 101. Moreover, sub-grids within the grid 101 may have different nominal voltages. For example, the power grid 101 may include a medium-voltage portion connected to a low-voltage portion through a distribution transformer.

The power grid 101 includes devices that generate, consume, transfer, distribute, and/or absorb electrical energy. The power grid 101 may include sources of electrical energy such as, for example, power plants, power generators, renewable energy sources, power stations, and/or one or more distributed energy resources (DER). A DER is an electricity-producing resource and/or a controllable load. Examples of DER include solar-based energy sources such as, for example, solar panels and solar arrays; wind-based energy sources, such as, for example, wind turbines and windmills; combined heat and power plants; rechargeable sources (such as batteries); natural gas-fueled generators; electric vehicles; and controllable loads, such as, for example, some heating, ventilation, air conditioning (HVAC) systems and electric water heaters.

The power grid 101 also may include one or more reclosers or switchgears, sectionalizers, transformers, and a point of common coupling (PCC) that provides an AC bus for more than one discrete load. The power grid 101 also includes transport media, such as, for example, transmission lines and electrical cables. All or part of the power grid 101 may be underground.

FIG. 1B is a side exterior view of the busway portion 140. FIG. 1C is a side exterior view of the tap-off box 150. Dashed lines in FIGS. 1B and 1C indicate hidden elements. The busway portion 140 includes a busway housing 145 and electrical conductors 147a, 147b, 147c in the busway housing 145. The electrical conductors 147a, 147b, 147c are electrically isolated from each other and from the busway housing 145 by insulation 149.

The busway portion 140 may include additional elements that are not shown in FIG. 1B. For example, the busway portion 140 may include auxiliary communication and/or data sub-channels that carry signals instead of load currents, ground conductor(s), electromagnetic interference (EMI) shielding, mounting for EMI shielding, and/or mechanical mounting features for attaching the busway housing 145 to structures in the facility 110 such as ceilings, walls, and/or posts.

The tap-off box 150 includes a tap-off housing 152 and a mast 160 that extends from the tap-off housing 152. The tap-off housing 152 is a durable enclosure or box with an exterior surface 151. The exterior surface 151 is grounded and may be safely handled by a human operator. The tap-off housing 152 may be, for example, steel. The mast 160 includes moveable electrical contacts 162a, 162b, 162c that are electrically connected to an electrical interface 158 via a current path 155. The electrical interface 158 is any type of electrical connection point for a load. The interface 158 may be an electrical cable 158. The electrical contacts 162a, 162b, 162c are made of an electrically conductive material such as, for example, copper, nickel, brass, or gold. The electrical contacts 162a, 162b, 162c are electrically connected to the current path 155. Three additional moveable electrical contacts may be on the opposite side of the mast 160.

The tap-off box 150 also includes a mechanism 157 for controlling the position of the moveable contacts 162a, 162b, 162c and a contact interface 156 coupled to the mechanism 157. The contact interface 156 is accessible from the exterior surface 151. The contact interface 156 is any type of interface that is moveable from a first position to a second position. For example, the contact interface 156 may be a knob, button, or handle that slides along a track formed in the tap-off housing 152. Movement of the contact interface 156 between the first and second positions drives the mechanism 157 to move or position the electrical contacts 162a, 162b, 162c.

The mechanism 157 is any mechanical linkage (such as a spring and/or rod) that moves the contacts 162a, 162b, 162c in response to movement of the contact interface 156. Referring also to FIG. 1D, in one implementation, the electrical contact 162a is a generally rectangular plate spring made of an electrically conductive material, with one end 163 of the plate spring contact 162a attached to the mast 160 and the other end 164 free to move. In this implementation, the free end 164 rests against the mast 160 when the contact interface 156 is in the first position (also referred to as a disconnection position). In response to the contact interface 156 moving to the second position (also referred to as a connection position), the mechanism 157 acts on the contact 162a such that the free end 164 of the electrical contact 162a is separated from the mast 160 against a spring-restoring force. The other electrical contacts 162b and 162c are configured in the same manner.

The mast 160 may be implemented in other ways. For example, the mast 160 may include more or fewer than three electrical contacts on each side.

The tap-off box 150 also includes a control interface 159 that is accessible from the exterior surface 151. The control interface 159 is a manually operated device (such as a switch or a button) that controls a state of a protective device 154 on the current path 155. The protective device 154 is any type of device that is capable of interrupting current in the current path 155. For example, the protective device 154 may be a breaker or a fusible switching device. When the protective device 154 is in an opened state, the current path 155 is opened or interrupted and electrical current cannot flow between the electrical contacts 162a, 162b, 162c and the cable 158. When the protective device 154 is in a closed state, the current path 155 is closed and electrical current can flow between the electrical contacts 162a, 162b, 162c and the cable 158.

In operational use, the mast 160 is inserted into an access point or opening 148 in the busway housing 145 and the tap-off housing 152 is attached to the busway housing 145 with a fastening system 133. The fastening system 133 is any type of mechanical fastener and may include components on the tap-off housing 152 and on the busway housing 145. For example, the fastening system 133 may be a tab on the busway housing 145 and a corresponding groove on the tap-off housing 152 that receives and holds the tab. In another example, the fastening system 133 may be clips(s) on the tap-off housing 152 and corresponding slot(s) on the busway housing 145. In this example, each clip is held in a corresponding slot with an interference fit, a frictional engagement, and/or a snap fit to secure the tap-off housing 152 to the busway housing 145. Regardless of the specific form of the fastening system 133, the tap-off housing 152 may be removed from the busway housing 145 without damaging the busway housing 145 or the tap-off housing 152.

When the tap-off box 150 is attached to the busway housing 145, each electrical contact 162a, 162b, 162c is aligned with a respective one of the conductors 147a, 147b, 147c and the contact interface 156 is in the disconnection position. The free end of each electrical contact 162a, 162b, 162c rests on the mast 160 and none of the electrical contacts 162a, 162b, 162c are in contact with any of the conductors 147a, 147b, 147c. The operator moves the contact interface 156 to the connection position to engage the electrical contact 162a with the conductor 147a, the electrical contact 162b with the conductor 147b, and the electrical contact 162c with the conductor 147c.

In some implementations, the contact interface 156 is also configured to supplement the mechanical attachment between the tap-off housing 152 and the busway housing 145 provided by the fastening system 133. For example, the contact interface 156 may include a knob that is rotatable when the contact interface 156 is in the connection position, and rotating the knob clamps the tap-off housing 152 to the busway housing 145.

When the contact interface 156 is in the connection position and the control interface 159 is positioned such that the protective device 154 is in the closed state, the cable 158 is electrically connected to the conductors 147a, 147b, 147c of the busway portion 140 via the current path 155, and the busway system 130 delivers electrical power to a load connected to the cable 158. In a standard procedure for removing the tap-off box 150 from the busway portion 144, an operator operates the control interface 159 to transition the protective device 154 to the opened state, thereby stopping the flow of electricity between the conductors 147a, 147b, 147c and the cable 158. The operator then moves the contact interface 156 from the connection position to the disconnection position to separate the electrical contacts 162a, 162b, 162c from the respective electrical conductors 147a, 147b, 147c. The tap-off box 150 can then be safely removed from the busway portion 140 by disengaging the fastening system 133.

Although this standard procedure provides a guide to ensure safe removal of the tap-off box 150 from the busway portion 140, the interlock 170 ensures that the tap-off box 150 is not inadvertently or intentionally disconnected from the busway 140 while the tap-off box 150 powers the device 190. As discussed in more detail below, the interlock 170 prevents disengagement of the electrical contacts 162a, 162b, 162c from the conductors 147a, 147b, 147c when current is flowing in the tap-off box 150, thereby preventing the arcing and/or short circuit condition that could otherwise occur.

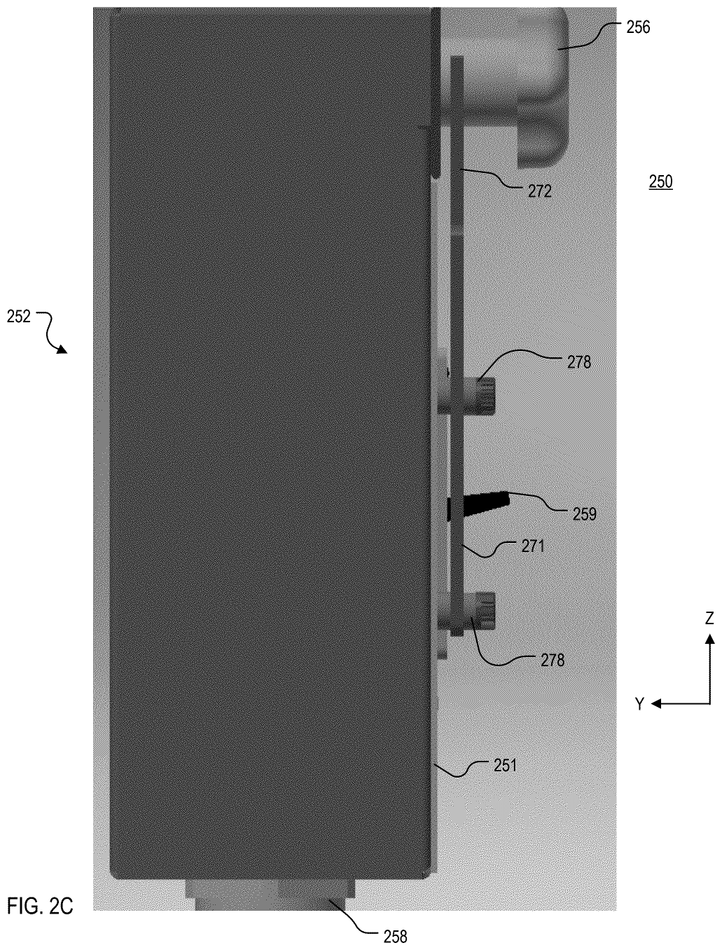

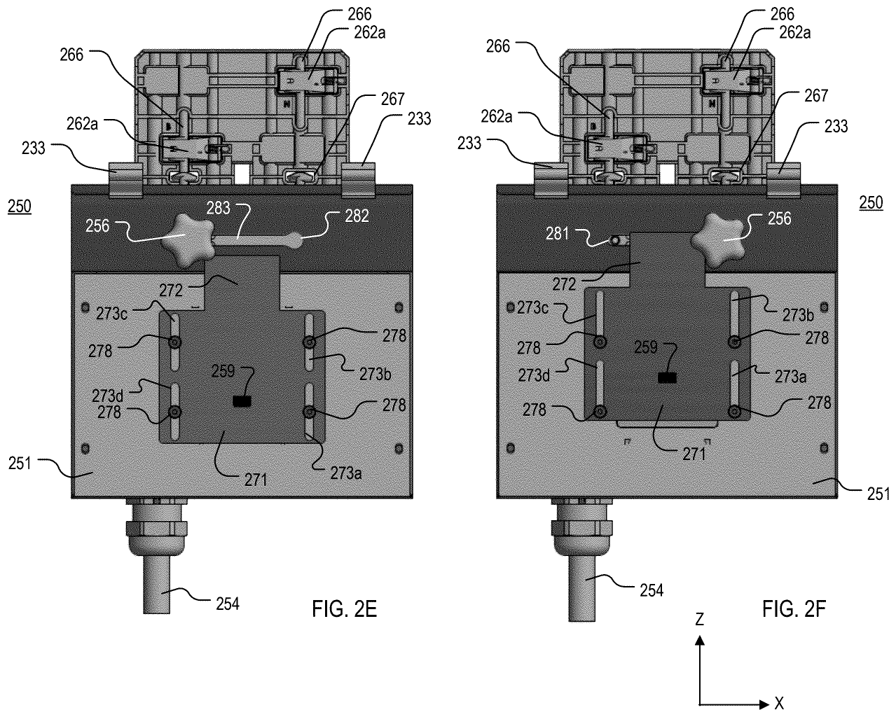

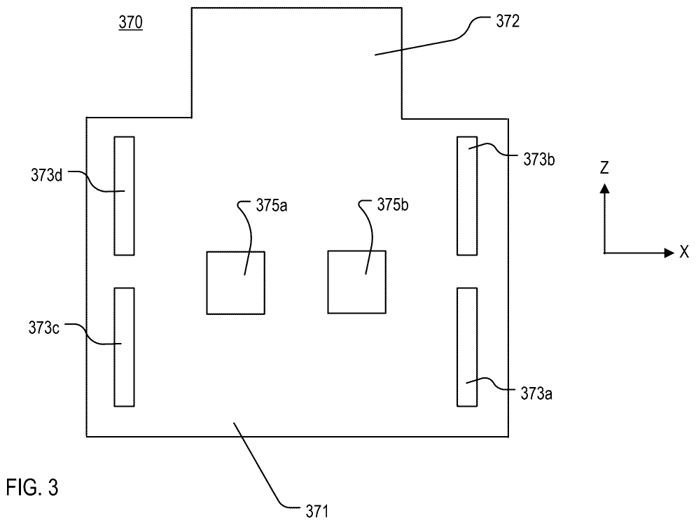

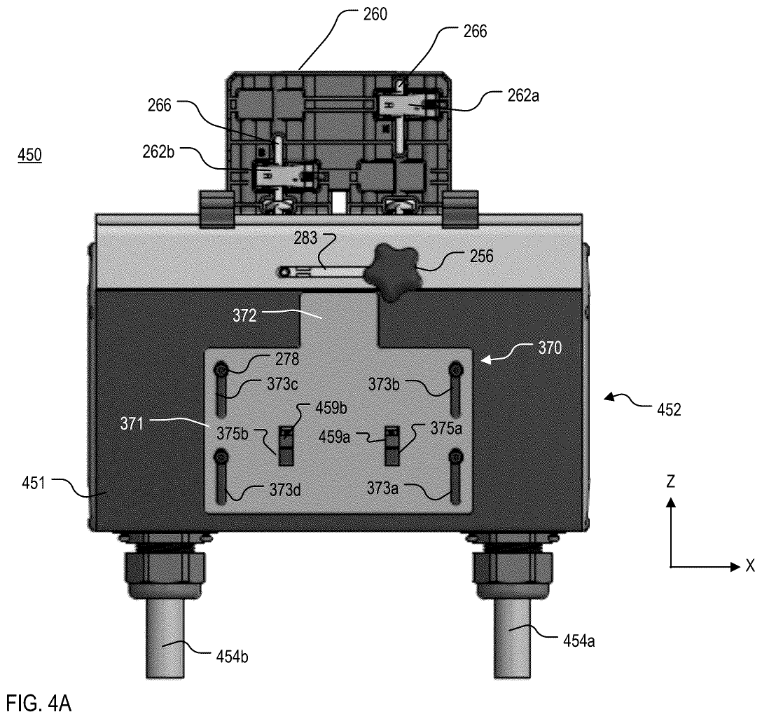

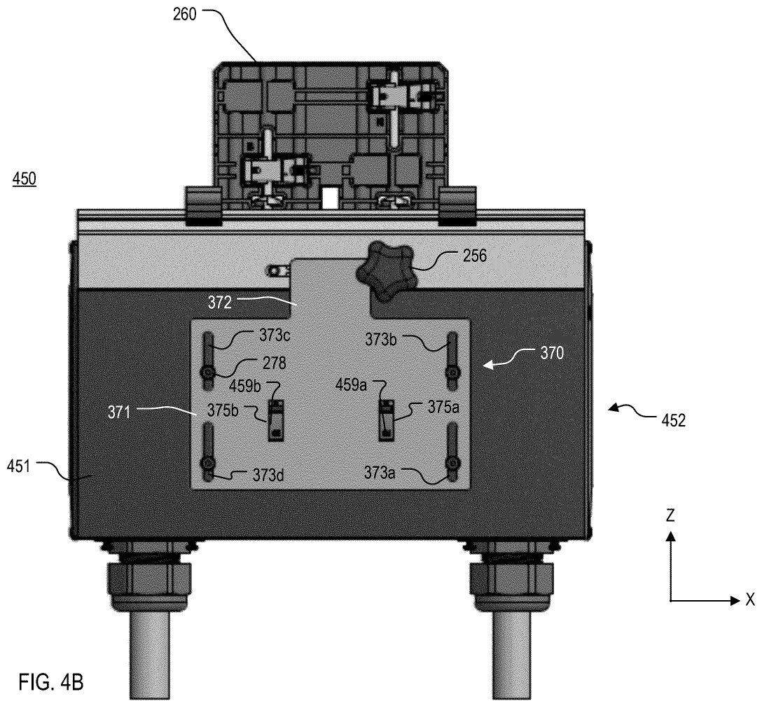

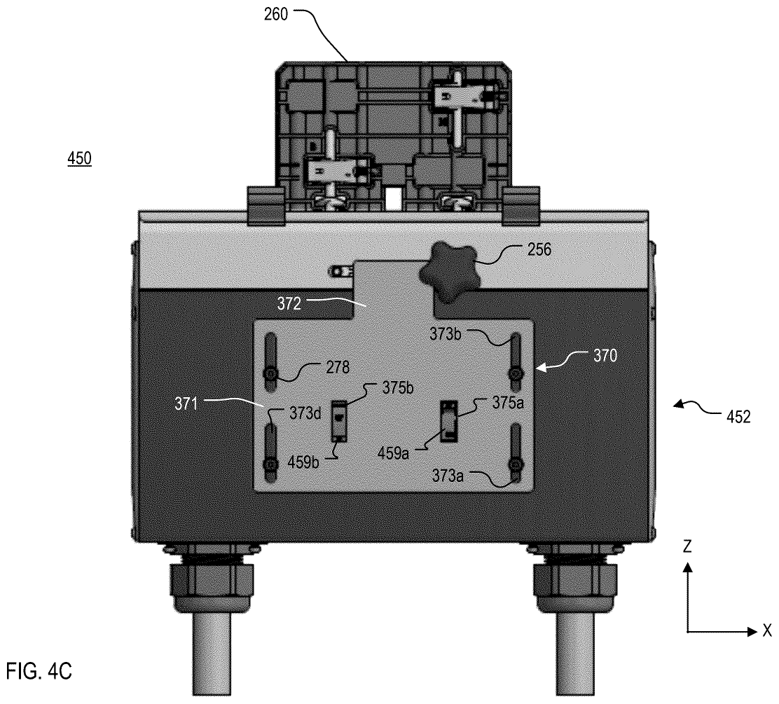

FIG. 2A is a perspective view of a tap-off box 250. The tap-off box 250 is another example of a tap-off box that can be used with a busway such as the busway portion 140 (FIG. 1A). The tap-off box 250 includes a housing 252 and a mast 260 that extends from the housing 252. The mast 260 includes electrical contacts 262a and 262b on a first side 265 of the mast 260 and two additional electrical contacts (not shown) on an opposite side of the mast 260. The electrical contacts 262a and 262b (and the electrical contacts on the opposite side of the mast 260) are collectively referred to as the electrical contacts 262. Each electrical contact 262 is configured to connect to or disconnect from a busway conductor of a busway in response to activation of a contact interface 256.

The tap-off box 250 also includes a control interface 259 that controls a protective device (not shown) in the housing 252. The protective device may be, for example, a fusible switching device or a breaker. The protective device may include more than one switching device. The control interface 259 is moveable between an opened position and a closed position. In the opened position, the electrical contacts 262 are electrically connected to a cable 258 that extends from the housing 252. In the closed position, the electrical contacts are not electrically connected to the cable 258.

The tap-off box 250 includes an interlock 270 slideably mounted on a front side 251 of the housing 252. The interlock 270 is made of any durable material. For example, the interlock 270 may be made of a metal such as steel or a solid polymer material. Referring also to FIG. 2B, the interlock 270 is a plate that extends generally in the X-Z plane. The interlock 270 includes a main portion 271 and a blocking portion 272 that extends from the main portion 271 in the Z direction. The main portion 271 has an extent in the X direction that is greater than the extent of the blocking portion 272 in X direction. The interlock 270 includes a control interface opening 275 and mounting openings 273a, 273b, 273c, 273d that pass through the main portion 271 in the Y direction (into and out of the page in FIG. 2B). The mounting openings 273a, 273b are on one side of the control interface opening 275 and the mounting openings 273c, 273d are on an opposite side of the control interface opening 275.

In the example shown, the main portion 271 and the blocking portion 272 are substantially rectangular. However, other implementations are possible. For example, the main portion 271 may be a square or a circle, and the blocking portion 272 may be a circle or an ellipse. In another example, the blocking portion 272 and the main portion 271 may have substantially the same extent in the X direction such that the interlock 270 is a rectangular or square plate. In another example, the interlock 270 includes a different number of mounting openings. For example, the interlock 270 may include two or six mounting openings instead of four.

Referring also to FIG. 2C, which is a partial side view of the tap-off box 250, the control interface 259 extends from the front side 251 and through the control interface opening 275. In the example shown, the control interface 259 is a switch. The interlock 270 is mounted to the front side 251 with four shoulder bolts 278. One shoulder bolt 278 passes through each of the mounting openings 273a, 273b, 273c, 273d. Two shoulder bolts 278 are shown in in FIG. 2C.

Referring also to FIG. 2D, the shoulder bolt 278 includes a threaded attachment 293, a spacer portion 294, a sliding portion 295, and a bolt head 296. The threaded attachment 279 connects to a corresponding threaded bore or other threaded connection point on the front side 251 of the tap-off housing 252. The spacer portion 294 has a greater diameter than the sliding portion 295, and the sliding portion 295 has a smaller diameter than the openings 273a, 273b, 273c, 273d. The spacer portion 294 may be positioned between the front side 251 and the interlock 270 to protect the front side 251 from damage during use of the interlock 270. The spacer portion 294 may be a nylon spacer.

When the interlock 270 is attached to the front side 251 with the shoulder bolts 278, each opening 273a, 273b, 273c, 273d surrounds the sliding portion 295 of one of the bolts 278 and the spacing portion 294 of that bolt 278 is between the main portion 271 and the front side 251. This arrangement separates the interlock 270 from the front side 251 and also allows the interlock 270 to slide relative to the front side 251.

Referring also to FIGS. 2E and 2F, the contact interface 256 includes a knob or slider that is moveable between ends 281 and 282 of a track 283. The track 283 may be a slotted opening in the front side 251 of the housing 252. The contact interface 256 controls the position of the electrical contacts 262. Each electrical contact 262 is a plate spring with one end attached to the mast 260 and the other end free to move relative to the mast 260, similar to the electrical contacts 162a, 162b, 162c discussed above. Each electrical contact 262 is positioned by a camming mechanism that includes a post 266 that extends between the electrical contact 262 and the mast 260. The posts 266 are secured to the side 265 by clips 267 that each receive a crank post or other mechanical linkage (not shown) that is attached to the contact interface 256. When the contact interface 256 is at the end 281, the free end of each electrical contact 262 rests on the mast 260 and the contact interface 256 is in a disconnection position. Moving the contact interface 256 from the end 281 to the end 282 rotates the posts 266 and moves the free end of each electrical contact 262 away from the mast 260. Moving the interface from the end 282 to the end 281 returns the free end of each electrical contact 262 to the mast 260.

The operation of the interlock 270 is driven by the motion of the control interface 259. FIG. 2E shows the tap-off box 250 with the interlock 270 disengaged and the control interface 259 in the opened position. The contact interface 256 is in the disconnection position at the end 281 of the track 283, and the free end of each electrical contact 262 rests on the mast 260. To transition the contact interface 256 to the connection position, the contact interface 256 is moved along the track 283 to the end 282. Moving the contact interface 256 along the track 283 also rotates the posts 266, and the free end of each electrical contact 262 moves away from the mast 260.

Referring also to FIG. 2F, with the contact interface 256 in the connection position, the control interface 259 is transitioned from the opened position to the closed position by moving the control interface 259 switch in the Z direction. Specifically, the control interface 259 extends through the control interface opening 275 on the interlock 270. When the control interface 259 moves in the Z direction, it interacts with the edge of the control interface opening 275 such that moving the control interface 259 in the Z direction also moves the interlock 270 in the Z direction. In other words, the interlock 270 is engaged by moving the control interface 259 into the closed position.

When the control interface 259 is in the closed position (FIG. 2F), the interlock 270 is engaged, the electrical contacts 262 are electrically connected to the cable 258, and the blocking portion 272 is between the ends 281 and 282 of the track 283. In this position, the blocking portion 272 of the interlock 270 blocks the track 283 and prevents the contact interface 256 from moving from the end 282 to the end 281. Thus, the interlock 270 prevents the electrical contacts 262 from being moved while current can flow through the tap-off box 250.

The interlock 270 can only be disengaged by moving the control interface 259 in the −Z direction into the opened position. The blocking portion 272 moves out of the space between the ends 281 and 282 of the track 283 when the control interface 259 reaches the opened position and the current path in the tap-off box 250 is opened. With the blocking portion 272 removed, the contact interface 256 may be moved from the connection position (the end 282) to the disconnection position (the end 281).

In operational use of the tap-off box 250 with a busway, when the contact interface 256 is in the connection position and the control interface 259 is in the closed position shown in FIG. 2E, each electrical contact 262 is engaged with a busway conductor and current can flow between the busway conductors and the cable 258. The blocking portion 272 of the interlock 270 is between the ends 281 and 282 of the track 283 and prevents the contact interface 256 from moving, thereby preventing the electrical contacts 262 from separating from the busway conductors while current flows in the tap-off box 250. Separating the electrical contacts 262 from the busway conductors while current is flowing in the tap-off box 250 may lead to arcing and short-circuit conductions, particularly in high-current conditions. By preventing the contact interface 256 from moving when the control interface 259 is in the closed position, the interlock 270 prevents or reduces arcing and short circuit conditions. To disconnect the tap-off box 250 from the busway, the operator moves the control interface 259 to the opened position, which interrupts the flow of electrical current between the contacts 262 and the cable 258 and lowers the interlock 270 such that the blocking portion 272 no longer prevents movement of the contact interface 256.

Furthermore, although the interlock 270 is configured to be engaged or disengaged based on the position of a single control interface, in other implementations, the interlock accommodates more than one control interface.

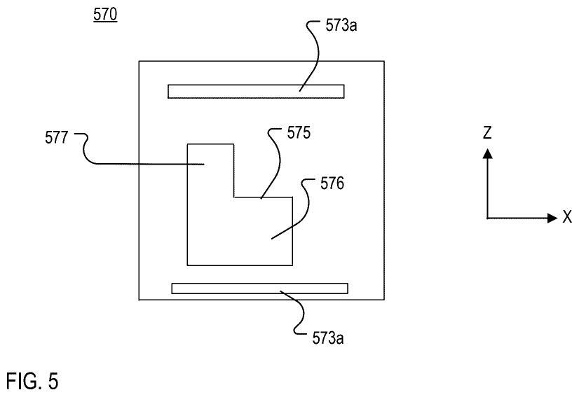

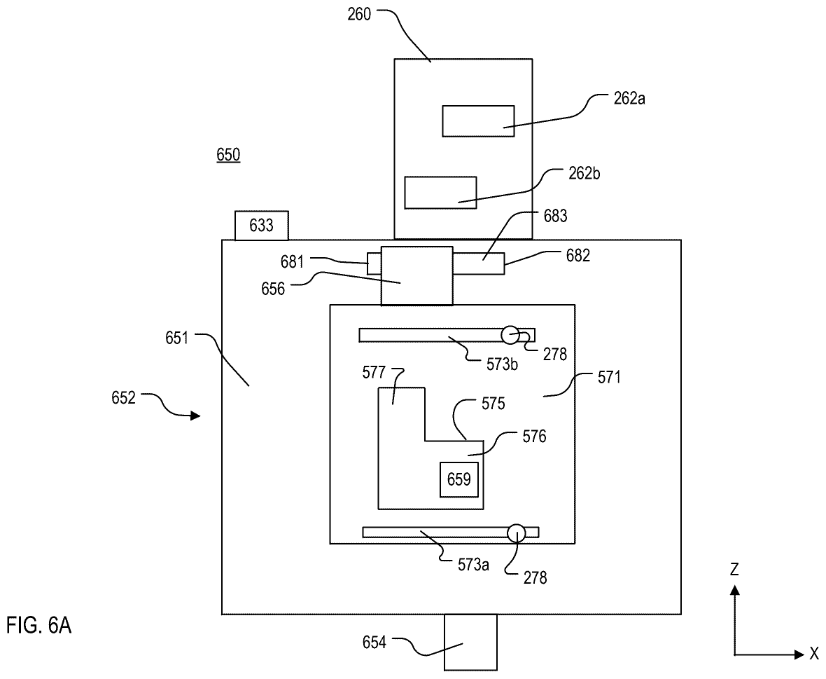

FIG. 3 shows an interlock 370 that is configured to be attached to a tap-off box 450 (FIGS. 4A-4C) that includes two control interfaces 459a and 459b. Referring to FIG. 3, the interlock 370 is a plate that extends generally in the X-Z plane and has mirror symmetry about a centerline that extends along the Z axis. The interlock 370 is similar to the interlock 270, except the interlock 270 includes two control interface openings 375a and 375b. The interlock 370 also includes a main portion 371 and a blocking portion 372 that extends from the main portion 371 in the Z direction. The blocking portion 372 has a smaller extent in the X direction than the main portion 371 has in the X direction. The interlock 370 has four mounting slots 373a, 373b, 373c, 373d. The mounting slots 373a and 373b are on one side of the main portion 371 and the mounting slots 373c and 373d are on the opposite side. Each mounting slot 373a, 373b, 373c, 373d is configured to receive one shoulder bolt 278 (FIG. 2D) to slideably mount the interlock 370 to the front side of a tap-off box. FIGS. 4A-4C show the interlock 370 mounted to the tap-off box 450, but the interlock 370 may be mounted to other tap-off boxes.

Other implementations of the interlock 370 are possible. For example, the interlock 370 may have more than two control interface openings. In another example, the interlock 370 may have two mounting slots instead of four. In yet another example, the interlock 370 may include more than one blocking portion 372 and may be used with a tap-off box that includes more than one interface, with each blocking portion configured to block one interface.

FIGS. 4A-4C are front views of a tap-off box 450 that includes a tap-off housing 452 and the mast 260, which extends from the tap-off housing 452. The interlock 370 is mounted to a front side 351 of the tap-off housing 452. The tap-off box 350 is another example of a tap-off box that can be connected to a busway such as the busway portion 140 (FIG. 1A). The tap-off box 450 includes a housing 452. The mast 260 extends from the housing 452, and the contact interface 256 controls the electrical contacts 262. The tap-off box 450 is similar to the tap-off box 250 except the tap-off box 450 includes two control interfaces 459a and 459b. The control interface 459a controls a protective device (not shown) in the housing 452 between the contacts 262 and a cable 454a, and the control interface 459b controls a protective device (not shown) in the housing between the contacts 262 and a cable 454b.

FIG. 4A shows the tap-off box 450 with the control interfaces 459a and 459b in the opened position, the electrical contacts 262 are disconnected from the cables 454a and 454b, and the interlock 370 disengaged. The contact interface 256 is in the connection position such that the free ends of the electrical contacts 262 are not resting on the mast. If the tap-off box 450 is attached to a busway, the electrical contacts 262 are in contact with conductors in the busway; however, current does not flow in the tap-off box 450 because the control interfaces 459a and 459b are in the opened position.

Referring to FIG. 4B, the control interfaces 459a and 459b are moved in the Z direction into the closed position and the electrical contacts 262 are connected to the cables 454a and 454b. The interlock 370 moves in the Z direction with the control interfaces 459a and 459b, and the blocking portion 373 of the interlock covers a portion of the track 283 to prevent the contact interface 256 from moving to the disconnection position. Referring to FIG. 4C, the control interface 459b is moved in the −Z direction to transition to the opened position, disconnecting the electrical contacts 262 from the cable 454b. The control interface 459a remains in the closed position, and the electrical contacts 262 remain connected to the cable 454a. Because only one of the control interfaces 459a, 459b moved in the −Z direction and the control interface 459a continues to support the interlock 370 in the engaged position, the interlock 370 does not move in the −Z direction and the blocking portion 373 continues to prevent the movement of the contact interface 256 while current can flow in the tap-off box 450.

Thus, like the interlock 270, the interlock 370 prevents the contact interface 256 from moving to the disconnection position while current is flowing in a tap-off box. Also like the interlock 270, the engagement and disengagement of the interlock 370 is driven by the movement of the control interfaces 459a, 459b and the interlock 370 cannot be disengaged unless both control interfaces 459a, 459b are moved to the opened position.

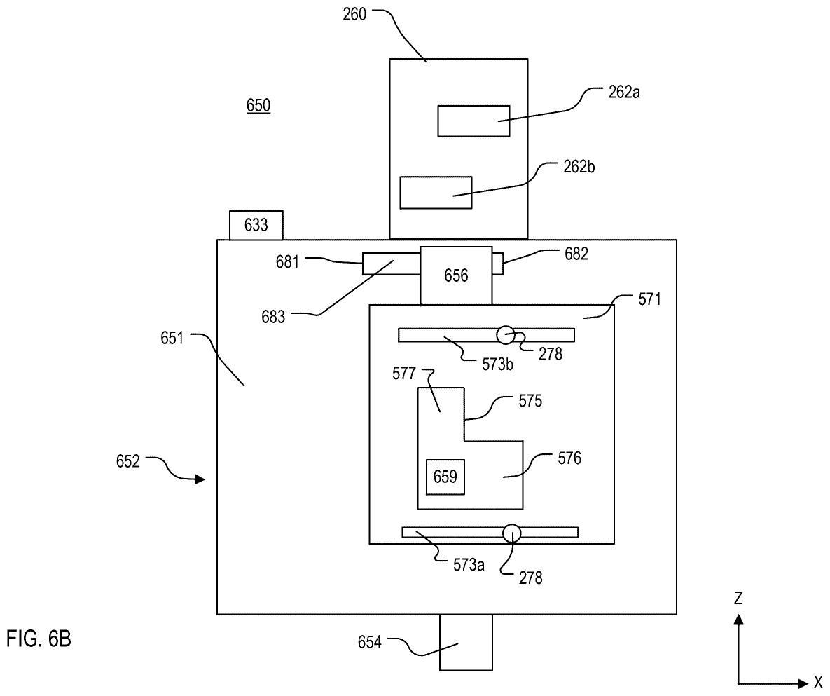

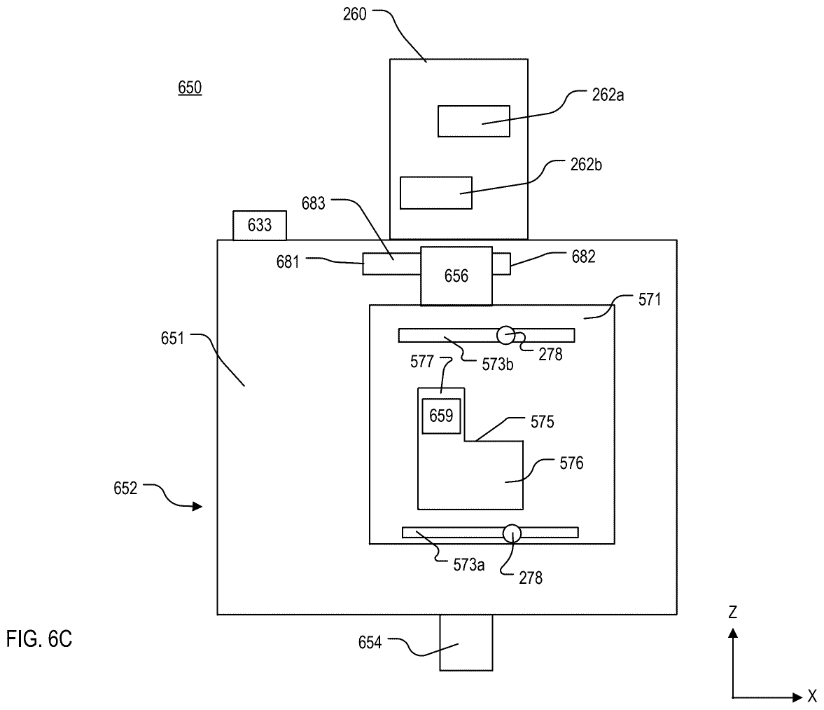

FIG. 5 shows another interlock 570. The interlock 570 is also configured to be mounted on a front side of a tap-off box. For example, the interlock 570 may be mounted on the front side 251 of the tap-off box 250 or on a tap-off box 650 (FIGS. 6A-6C). The interlock 570 is a plate that extends in the X-Y plane. The interlock 570 may be made of any durable material. For example, the interlock 570 may be made of metal (such as steel) or a solid plastic. The interlock 570 includes a plate body 571; mounting openings 573a, 573b; and a control interface opening 575. Each mounting opening 573a, 573b is configured to receive one shoulder bolt 278 to mount the interlock 570 to a front side of a tap-off box.

The control interface opening 575 is configured to receive a control interface (such as a switch or button) that extends from the front side of the tap-off box. The control interface opening 575 includes a lower region 576 and an upper region 577.

FIGS. 6A-6C show the interlock 570 attached to a front side 651 of a tap-off box 650. The tap-off box 650 is another example of a tap-off box that can be connected to a busway such as the busway portion 140 (FIG. 1A). The tap-off box 650 includes a tap-off housing 652 and the mast 260, which extends from the tap-off housing 652, and a control interface 659 that extends from the front side 651. The control interface 659 is any type of device that controls the operation of a protective device. For example, the control interface 659 may be a switch, toggle, or knob that moves in the Z and −Z directions. The control interface 659 is moveable between a closed position (FIGS. 6C) and a opened position (FIGS. 6A and 6B). Placing the control interface 659 in the closed position closes a protective device (not shown) inside the housing 652 such that the electrical contacts 262 are electrically connected to a cable 654 that extends from the housing 652. The cable 654 is configured to power a load. Thus, when the control interface 659 is in the closed position, electrical current can flow in the tap-off box 650 and the tap-off box 650 can power a load. Placing the control interface 659 in the opened position opens the protective device inside the housing 652 such that the electrical contacts 262 are not electrically connected to the cable 654. When the control interface 659 is in the closed position, electrical current does not flow in the tap-off box 650.

The tap-off box 650 also includes a contact interface 656, which is similar to the contact interface 256. The contact interface 656 is a manually controllable interface that slides in a track 683 that extends generally along the X direction from an end 681 to an end 682. The contact interface 656 controls the electrical contacts 262 on the mast 260 as discussed above. When the contact interface 656 is at or near the end 681 (as shown in FIG. 6A), the free ends of the electrical contacts 262 rest on the mast 260 and the contact interface 656 is in a disconnection position. When the contact interface 656 is at or near the end 682 (as shown in FIGS. 6B and 6C), the free ends of the electrical contacts 262 are separated from the mast 260 and the contact interface 656 is in a connection position.

The interlock 570 is slideably attached to the front side 651 with shoulder bolts 278. The interlock 570 is also coupled to the contact interface 656 such that the interlock 570 moves in the +X and −X directions with the contact interface 656. The contact interface 656 may be, for example, a knob that is attached to a slider, with the knob extending outward and the slider resting in the track 683. In these implementations, the interlock 570 may be attached to the knob.

The shape of the control interface opening 575 ensures that the control interface 659 is not transitioned from the closed position to the opened position while the control interface 659 is in the closed position. In operational use, the tap-off box 650 is attached to a busway such as the busway portion 140 (FIGS. 1A and 1B) with a fastening system 633. Initially, the contact interface 656 is in the disconnection position, and the control interface 659 is in the lower region 576 of the opening 575 and is in the opened position, as shown in FIG. 6A.

Referring to FIG. 6B, once the housing 652 is attached to the busway, the contact interface 656 is moved in the X direction along the track 683 from the disconnection position to the connection position such that the electrical contacts 262 engage with the conductors of the busway. The interlock 570 moves in the X direction with the contact interface 656. The lower region 576 extends far enough along the X axis that the contact interface 656 is able to move between the connection and disconnection positions while the control interface 659 remains in the opened position. The control interface 659 is at the bottom of the lower region 576.

Referring to FIG. 6C, the control interface 659 is moved in the Z direction into the closed position and into the upper region 577 of the control interface opening 575. Electrical current can now flow in the tap-off box 650. With the interlock 670 engaged as shown in FIG. 6C, the control interface 659 extends through the upper region 577 and constrains the motion of the contact interface 656. Thus, the interlock 570 prevents the contact interface 656 from moving to the disconnection position until the control interface 659 is returned to the opened position. In this way, the interlock 570 also prevents or reduces arcing and short circuit conditions that could occur if the tap-off box 650 was disconnected from the busway while under load.

Other implementations of the interlock 570 are possible. For example, the interlock 570 may have more than one control interface opening 575 to accommodate a tap-off box that includes more than one control interface. In another example, the control interface opening 575 may be shaped other than shown in FIG. 5. For example, the control interface opening 575 may have curved edges.

These and other implementations are within the scope of the claims. For example, any of the interlocks 170, 270, 370, and 570 may be pre-installed on a tap-off box and sold as a unit, or the interlocks 170, 270, 370, and 570 may be sold as a kit to retrofit an existing tap-off box. The kit may include mechanisms such as shoulder bots, to attach the interlock to a tap-off box.

In another example, attachment mechanism(s) other than the shoulder bolt 278 may be used to attach the interlock 270, 370, and 570 to a tap-off box. Any attachment mechanism that secures the interlock 270, 370, 570 to a tap-off box and also allows the interlock to slide relative to the tap-off box may be used instead of or in addition to the shoulder bolt 278. For example, any type of bolt or rivet could be used instead of the shoulder bolts 278. In some implementations, each shoulder bolt 278 is replaced with a bushing attached by a bolt or a screw, where the bushing prevents the mounting openings from making direct contact with the bolt threads.

What is claimed is:

1. A tap-off box comprising:
a housing comprising: an exterior, an interior, and a current path in the interior;
a single mast comprising moveable electrical contacts electrically connected to the current path;
a contact interface moveable between a connection position in which the moveable electrical contacts are positioned for electrical connection to a busway conductor and a disconnection position in which the moveable electrical contacts are not positioned for electrical connection to the busway conductor;
a control interface that is moveable between an opened position in which the current path is open and a closed position in which the current path is closed; and
an interlock that prevents movement of the contact interface from the connection position to the disconnection position when the control interface is in the closed position.

2. The tap-off box of claim 1, wherein the interlock comprises: a plate and an opening that passes through the plate.

3. The tap-off box of claim 2, wherein the opening is over the control interface and the control interface extends through the opening.

4. The tap-off box of claim 2, wherein the tap-off box comprises a plurality of control interfaces, the interlock comprises a plurality of openings, and each control interface extends through one of the plurality of openings.

5. The tap-off box of claim 2, wherein the plate comprises a main portion and a blocking portion; the plate moves with the control interface; and, when the control interface is in the closed position, the blocking portion is between the connection position and the disconnection position such that the interlock prevents the contact interface from being placed in the disconnection position.

6. The tap-off box of claim 5, wherein the opening passes through the main portion of the plate.

7. The tap-off box of claim 6, wherein the control interface extends through the opening.

8. The tap-off box of claim 7, wherein the plate is slideably mounted to the exterior.

9. The tap-off box of claim 2, wherein the tap-off box comprises only a single contact interface, the plate is slideably mounted to the exterior, and the plate is mechanically coupled to the single contact interface.

10. The tap-off box of claim 9, wherein the control interface extends through the opening.

11. The tap-off box of claim 10, wherein the opening is shaped such that the plate only moves with the interface when the control interface is in the opened position.

12. The tap-off box of claim 11, wherein the opening is substantially L-shaped.

13. A tap-off box comprising:
a housing comprising: an exterior, an interior, and a current path in the interior;
a mast comprising at least one electrical contact that is electrically connected to the current path;
a contact interface moveable between a connection position in which the at least one electrical contact is positioned for electrical connection to a busway conductor and a disconnection position in which the at least one electrical contact is not positioned for electrical connection to the busway conductor;
a control interface moveable between an opened position in which the current path is open and a closed position in which the current path is closed; and
an interlock comprising: a blocking portion, and an opening positioned over the control interface, the interlock configured to move between a locked position corresponding to the closed position and an unlocked position corresponding to the opened position, wherein, when the control interface is in the closed position and the contact interface is in the connection position, the blocking portion prevents the contact interface from moving to the disconnection position.

14. The tap-off box of claim 13, wherein the interlock comprises a plate comprising a main portion, and the blocking portion extends from the main portion.

15. The tap-off box of claim 14, wherein the blocking portion moves into a space between the connection position and the disconnection position in response to the control interface moving into the closed position.

16. The tap-off box of claim 15, wherein the interior comprises a plurality of current paths; the mast comprises a plurality of electrical contacts; each of the plurality of electrical contacts connected to one of the plurality of current paths; the tap-off box comprises a plurality of control interfaces, each control interface configured to open or close one of the plurality of current paths; and the interlock comprises a plurality of openings, each opening positioned over one control interface; and wherein
the blocking portion moves into the space between the connection position and the disconnection position in response to any of the plurality of control interfaces moving into the closed position.

17. The tap-off box of claim 15, wherein the interior comprises a plurality of current paths; the mast comprises a plurality of electrical contacts; each of the plurality of electrical contacts connected to one of the plurality of current paths; the tap-off box comprises a plurality of control interfaces, each control interface configured to open or close one of the plurality of current paths; and the opening is positioned over all of the plurality of control interfaces; and wherein
the blocking portion moves into the space between the connection position and the disconnection position in response to any of the plurality of control interfaces moving into the closed position.

18. An interlock for a tap-off box, the interlock comprising:
a plate comprising: a main portion, and a blocking portion that extends from the main portion in a first direction;
one or more control interface openings in the main portion, each control interface opening configured to be positioned over a control interface of the tap-off box; and
a mounting device configured to attach the main portion of the plate to a mounting element on an exterior of the tap-off box such that, after attachment, the plate is configured to slide relative to the exterior of the tap-off box between a blocked position and an unblocked position in response to movement of a control interface.

19. The interlock of claim 18, wherein the mounting device comprises a mounting opening configured to receive a shoulder bolt that extends from an exterior of the tap-off box.

20. The interlock of claim 18, wherein the blocking portion has an extent in a second direction that is less than an extent of a travel path of a moveable interface on the tap-off box.
